(19) United States
(12) Patent Application Publication
(10) Pub. No.: US 2010/0089710 A1
(43) Pub. Date: Apr. 15, 2010

(54) BRAKE DISK

(76) Inventor: Michael Franke, Dresden (DE)

Correspondence Address: KENYON & KENYON LLP, ONE BROADWAY, NEW YORK, NY, 10004, US

(21) Appl. No.: 12/574,189

(22) Filed: Oct. 6, 2009

(30) Foreign Application Priority Data
Oct. 14, 2008 (DE) 102008042818.3

(51) Int. Cl. F16D 65/12

(52) U.S. Cl. 188/218 XL

(57) ABSTRACT

A brake disk has a friction ring and a disk chamber connected to the friction ring via connecting links. The connecting links are made of ceramic material, in this instance. Aluminum oxide or zirconium oxide may be used in this connection, for example.

### FIELD OF THE INVENTION

The present invention relates to a brake disk, especially a ventilated brake disk having a friction ring and a supporting structure connected to the friction ring via connecting links, particularly a disk chamber.

### BACKGROUND INFORMATION

A ventilated brake disk is described in German Patent No. DE 43 32 951, which has a friction ring and a supporting structure connected to the friction ring using connecting links. The connecting links are especially developed as pins, bolts or the like, and are positioned over the circumference of the supporting structure. The connecting links project into recesses in the circumferential wall of the friction ring. Furthermore, a brake disk is described in post-published German Patent No. DE 10 2007 054 393, in which the friction ring, produced of various materials, and the disk chamber are also connected using connecting links, especially pins. In all these brake disks known from the related art, the heat created at the friction ring is disadvantageously transferred to the disk chamber via the connecting links. Furthermore, the insufficient mobility of the connecting links may cause noises in the friction ring, and deformations may possibly occur in the friction ring or even in the disk chamber. Since the brake disks are exposed to environmental conditions, especially salt during wintertime and dampness, the mobility of the pins is substantially impaired based on corrosion. In practice, since up to now exclusively stainless steel pins or high-grade steel pins have been used as connecting links, the corrosion problem could not be fully excluded up to now.

### SUMMARY OF THE INVENTION

The brake disk according to the present invention has the advantage that the existing conditions of installation of the brake disk do not have to be changed, but the disadvantages named above are avoided. Contact corrosion between the connecting links and the friction ring or the disk chamber is able to be avoided by the use of ceramic materials for the connecting links. Furthermore, the heat may be kept in the friction ring, and thus, the heat generated during braking is able to be dissipated directly into the environment again. Consequently, heat transfer into the disk chamber is greatly reduced. Furthermore, it is possible to develop the connecting links to have good sliding properties in the friction ring. Because of that, the friction ring is able to move particularly simply based on the thermal expansion at the connecting links. Since ceramic materials are extraordinarily suitable for being cast around, using metallic materials, the surface quality of a connecting link is able to be adjusted for the friction ring and for the disk chamber on an individual basis. Therefore it is possible to develop the shaft of a connecting link, that is, the region of it extending into the friction ring, to be very smooth and to have good sliding properties. By contrast to this, it is possible to develop the head of a connecting link to have rougher surfaces or to have microprofiling, so that there is a very good heat interconnection between the connecting links and the disk chamber made of metallic materials or aluminum during casting. Furthermore, it is possible in a simple manner to adjust the connecting links in individual stress cases, particularly to the demands with respect to the modulus of elasticity and bending strength.

### BRIEF DESCRIPTION OF THE DRAWINGS

FIG. 1 shows a top view of a brake disk.

FIG. 2 shows a partial section A-A through the brake disk in FIG. 1.

FIG. 3 shows a section according to FIG. 1.

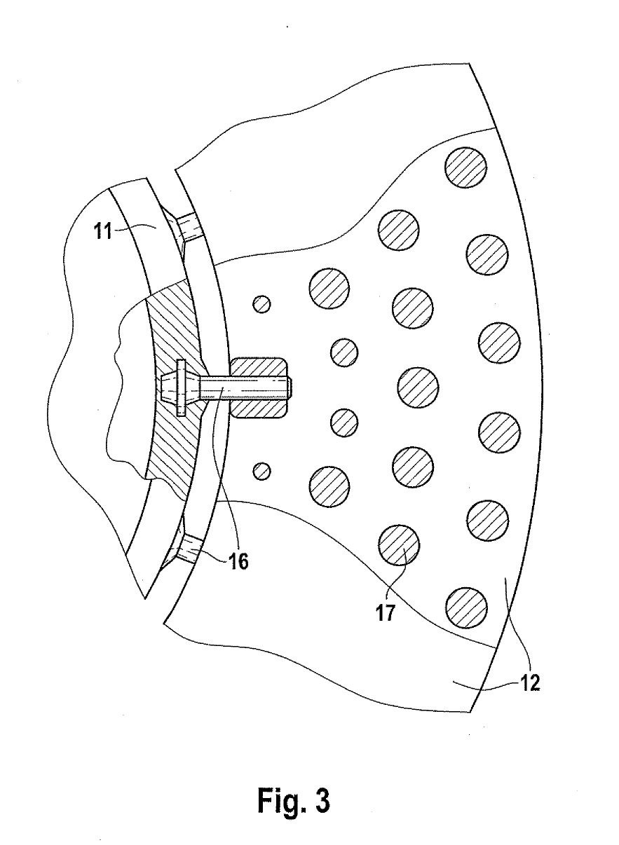

### DETAILED DESCRIPTION

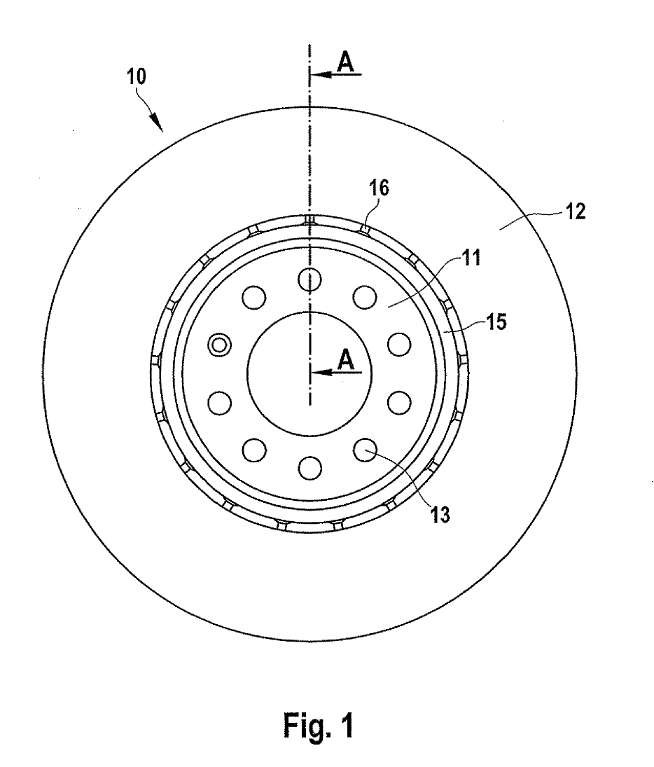

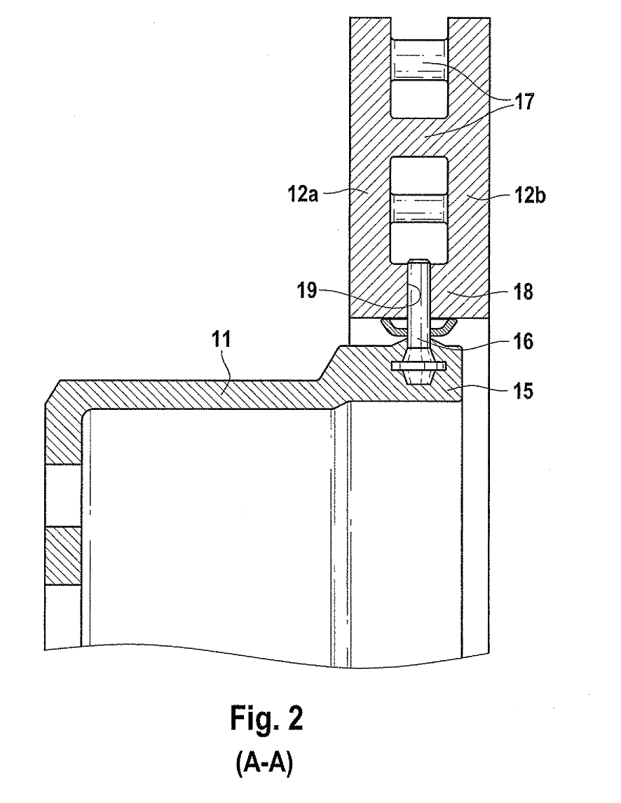

In FIG. 1, 10 designates a brake disk made up of a disk chamber 11 and a friction ring 12. In a known manner, disk chamber 11 is fastened to a hub of a vehicle, in a manner not shown here, the screws for fastening it extending through boreholes 13 of disk chamber 11. Disk chamber 11 is connected to friction ring 12, via a plurality of connecting links in the form of pins 16 or bolts or the like, that are formed into circumferential wall 15 of disk chamber 11. Friction ring 12 is made up of two friction ring halves 12a and 12b (FIG. 2), which are connected to each other by a plurality of crosspieces 17 that are distributed over the circumference and run particularly in the radial direction, so that a ventilated brake disk is created. From section to section, carrier crosspieces 18 are developed in the area of the inner circumference of friction ring 12. These carrier crosspieces 18 have a straight-through bore 19 for accommodating pins 16. However, blind-end bores would also be conceivable. Bores 19 are developed in the figures in the center line of friction ring 12. However, an offset of these bores 19 would also be possible.

Friction ring 12 is made of cast iron, while disk chamber 11 is made of a light metal, particularly aluminum or magnesium. Pin 16 is made of a ceramic material. During production, friction ring 12 that is made of cast iron is produced first, and pins 16 are inserted into bore 19. Thereafter, disk chamber 11 is cast on. In this process, the heads of pins 16 are also cast into outer wall 15 of disk chamber 11.

Friction ring 12 is float-mounted on disk chamber 11. To do this, pins 16 have to be situated in bores 19 so as to have relatively little play, so that friction ring 12 is able to move slightly onto pin 16. This is necessary since, during the braking procedure, friction ring 12 heats up and expands slightly away from disk chamber 11 in the radial direction. In an especially advantageous manner, the shaft of pins 16 is produced to have as smooth as possible a surface. Thereby, the shaft of pins 16 has good slideability in bores 19. By contrast, the heads of pins 16 have a relatively rough surface compared to the shaft. A head may furthermore have so-called microprofiling. Because of this development of the surface of the heads, a very good material composite is possible, during the casting process, of pin 16 made of ceramic material and disk chamber 11 made of metallic materials. Thus, when ceramic materials are used, pin 16 is able to be adjusted in a simple manner to the required surface quality, particularly also in sections. Now, it is also important that, because of the selection of the use of suitable ceramic materials, one is able to adapt to the respective requirements when passenger cars, trucks or racing vehicles are involved. Thus, one is able to adapt the modulus of elasticity and the bending strength to the respective requirements in a simple manner.

It is particularly advantageous if an aluminum oxide ceramic or a zirconium oxide ceramic is used as the ceramic material. In the case of the aluminum oxide ceramic, a ceramic material is involved that is made based on highly pure aluminum oxide (99.7%) having a slight admixture of magnesium oxide. This aluminum oxide ceramic (Al₂O₃) has a density of 3.9 g/cm³, a hardness of 400 HV, a compressive strength of 2800 N/mm², a bending strength of 340 MPa at room temperature, and a modulus of elasticity of 380 GPa. In the case of zirconium oxide ceramics, a ceramic material may be involved that is based on highly pure zirconium oxide that may be partially stabilized using various oxides. The designation ZrO₂—3Y means a zirconium oxide ceramic of highly pure zirconium oxide that is partially stabilized with 3 mol Y₂O₃. Its properties are a density of 6.03 g/cm³, a hardness of 1300 HV, a compression strength of 4000 N/mm² and a bending strength of 1200 MPa at room temperature. The designation ZrO₂—3Y20A means a dispersion ceramic based on partially stabilized zirconium oxide and aluminum oxide, the two oxides leading to an increase in the strength and fracture toughness compared to pure zirconium oxide (ZrO₂). Its density amounts to 5.5 g/cm², the hardness is 1300 HV and the bending strength is 2400 MPa at room temperature and 800 MPa at 1000° C. One may use the ceramic LPS-SiC as an additional material for pins 16. Because of its special structural features compared to other ceramics, especially other SIC materials, LPS-SIC has a higher fracture toughness. Its density amounts to 3.18 g/cm³, its bending strength 590 MPa, its fracture toughness (KIC) 6.9 MPa/m² and its specific electrical resistance 0.2 to 0.5 Ω/cm.

What is claimed is:

1. A brake disk comprising:
a friction ring having a circumferential wall;
a supporting structure; and
a plurality of connecting links situated at a circumference of the supporting structure and connected to the supporting structure, the connecting links extending into the circumferential wall of the friction ring, the connecting links being made of ceramic material.

2. The brake disk according to claim 1, wherein a density of the ceramic material is between 3.9 and 6 g/cm³.

3. The brake disk according to claim 1, wherein a bending strength of the ceramic material is between 340 and 120 MPa.

4. The brake disk according to claim 1, wherein the ceramic material is aluminum oxide (Al₂O₃).

5. The brake disk according to claim 1, wherein the ceramic material is zirconium oxide (ZrO₂).

6. The brake disk according to claim 5, wherein the ceramic material is ZrO₂—3Y20A.

7. The brake disk according to claim 5, wherein the ceramic material is ZrO₂—3Y.

8. The brake disk according to claim 1, wherein the ceramic material is silicon carbide.

9. The brake disk according to claim 8, wherein the ceramic material is LPS-SiC.

10. The brake disk according to claim 1, wherein the brake disk is a ventilated brake disk.
